(19) United States
(12) Patent Application Publication
(10) Pub. No.: US 2026/0194687 A1
(43) Pub. Date: Jul. 9, 2026

(54) CARBON DIOXIDE WELL INJECTION SIMULATION TECHNIQUES

(71) Applicant: Schlumberger Technology Corporation, Sugar Land, TX (US)

(72) Inventors: Lei Jiang, Cambridge, MA (US); William Bailey, Cambridge, MA (US); Peter Tilke, Cambridge, MA (US); Florian Hollaender, Cambridge, MA (US); Romain Prioul, Cambridge, MA (US)

(21) Appl. No.: 19/442,567

(22) Filed: Jan. 7, 2026

Related U.S. Application Data
(60) Provisional application No. 63/742,620, filed on Jan. 7, 2025.

(51) Int. Cl. G01V 99/00; E21B 49/00

(52) U.S. Cl. CPC G01V 99/00; E21B 49/00; E21B 2200/20

(57) ABSTRACT

Techniques for simulating carbon dioxide injection into a saline aquifer. The techniques include obtaining geological reference data and establishing carbon dioxide injection parameters. With this data and parameters in mind, a node-based resistance grid may be established that is used to schematically generate flowlines across the saline aquifer. From the flowlines, tessellated partitions may be developed and potentially subdivided into manageable platonic shape portions. Thus, a mathematical manner of estimating flow characteristics for the proposed injection application may be simulated in a fast and reliable manner.

### PRIORITY CLAIM/CROSS REFERENCE TO RELATED APPLICATION(S)

This Patent Document claims priority under 35 U.S.C. § 120 to U.S. App. Ser. No. 63/742,620, entitled “METHODS FOR FAST SIMULATION OF CARBON DIOXIDE INJECTION INTO A BRINE AQUIFER”, filed on Jan. 7, 2025 and incorporated herein by reference in its entirety.

### BACKGROUND

Injecting carbon dioxide (CO₂) into deep saline aquifers represents a critical strategy for long-term geological storage of greenhouse gases. Saline aquifers are porous and permeable formations saturated with brine, which are typically located at depths where pressures and temperatures allow CO₂ to remain in a dense phase, improving storage efficiency. For safe containment, these aquifers are commonly overlain by an impermeable cap rock—commonly referred to as an aquitard—that acts as a seal to prevent upward migration of CO₂. In addition to this primary sealing feature, geological constraints such as the absence of open or potentially open faults, fractures, and other discontinuities are other common characteristics that may help to minimize leakage risk. Along these lines, site selection for CO₂ storage generally also accounts for potential faults and fractures that might be present which could connect to shallower formations and compromise containment.

Beyond geological considerations, practical business factors strongly influence the viability of a CO₂ storage project. Cost minimization and operational efficiency are paramount. Proximity to major CO₂ sources reduces transportation costs and simplifies logistics. Ideal candidates include sites near industrial emitters such as cement plants, steel mills, paper mills, power generation facilities, chemical plants, and refineries. Locating injection sites near these emitters enables direct pipeline connections and reduces the need for costly compression and transport infrastructure.

Depth selection is another factor to consider. For example, the shallower the target aquifer the greater the reduction in drilling and completion costs. At the same time, sufficient depth may help to avoid interference with freshwater aquifers or zones used for agriculture and/or municipal water supplies. Indeed, regulatory frameworks often require a significant vertical separation between the injection zone and potable water formations to ensure environmental protection.

With the above in mind, existing wells in mature or abandoned oil or gas fields can offer economic advantages by reducing the need for new drilling. These wells may serve as injection or monitoring points, leveraging prior investments in infrastructure and subsurface characterization. However, their presence may also introduce additional risk. For example, abandoned or poorly sealed wells can act as leakage pathways for injected CO₂. Therefore, comprehensive integrity assessments and remediation plans may be undertaken to mitigate these risks.

Other considerations include reservoir heterogeneity, which affects CO₂ plume migration and pressure distribution, and the availability of geological data. Saline aquifers often lack detailed characterization because they were historically bypassed during hydrocarbon exploration. This uncertainty underscores the importance of advanced simulation techniques to predict flow behavior, pressure evolution, and containment performance under various injection scenarios.

In summary, successful CO₂ storage in saline aquifers involves balancing geological suitability with economic practicality. Selected sites should combine robust containment features—such as impermeable cap rocks and fault-free geometries—with logistical advantages like proximity to industrial emitters and existing infrastructure. Addressing these technical and business constraints through rigorous site screening and simulation may ensure safe, cost-effective, and scalable carbon sequestration.

With the above uncertainties in mind, proposals for modeling homogeneous reservoirs or aquifers have been proposed. However, these proposals tend to presume constant porosity and permeability characteristics for these reservoirs. Unfortunately, the reality is that the targeted saline aquifer is likely to be heterogenous in such porosity and permeability characteristics from one location to another along the same reservoir. Thus, the usefulness in modeling and predicting the overall capacity of a given saline reservoir in terms of carbon dioxide capacity remains limited.

### SUMMARY

An embodiment of the present disclosure described herein is directed at a method of simulating carbon dioxide injection into a saline aquifer. The method includes obtaining geological reference data correlated to a saline aquifer formation layer and establishing a set of carbon dioxide injection parameters. The parameters are for simulation of an injection application directed through at least one injection well in fluid communication with the saline aquifer formation layer. With the data and parameters set, mathematically plotting a plurality of flowlines emanating from the at least one injection well may take place with each flowline of the plurality of flowlines traversing the aquifer formation layer. With the flowlines plotted, partitioning the saline aquifer formation layer into a plurality of discrete partitions may take place based on the mathematical plotting of the plurality of flowlines. Thus, ultimately, estimating carbon dioxide flow characteristics for each discrete partition of the plurality may occur based on the geological reference data and the carbon dioxide injection parameters.

Another embodiment of the present disclosure described herein is another method of simulating carbon dioxide injection into a saline aquifer that includes obtaining geological reference data correlated to a saline aquifer formation layer and establishing a set of carbon dioxide injection parameters for simulation of an injection application. The simulated applications is directed through at least one injection well in fluid communication with the saline aquifer formation layer and includes reliance on a node-based resistance grid for the aquifer formation layer that is based on the geological reference data and the carbon dioxide injection parameters. Thus, mathematically plotting a plurality of flowlines along the node-based resistance grid with each flowline emanating from the at least one injection well may ensue and partitioning the saline aquifer formation layer into a plurality of discrete partitions based on the mathematical plotting of the plurality of flowlines may take place. Therefore, estimating carbon dioxide flow characteristics for each discrete partition of the plurality based on the geological reference data and the carbon dioxide injection parameters may occur.

In still another embodiment of the present disclosure described herein is an operation field arrangement. The arrangement includes at least one injection well at an operation field having a saline aquifer formation layer. A control unit for running a simulation of carbon dioxide injection into the aquifer is also available. The simulation includes obtaining geological reference data correlated to the saline aquifer formation layer and accounting for a set of carbon dioxide injection parameters for the simulation. The saline aquifer formation layer is represented with a plurality of flowlines developed from a node-based partition grid to facilitate mathematically developing a plurality of discrete partitions for estimating carbon dioxide flow characteristics for each discrete partition of the plurality. This is based on the geological reference data and the carbon dioxide injection parameters.

### BRIEF DESCRIPTION OF THE DRAWINGS

The appended figures illustrate only exemplary embodiments and are therefore not to be considered limiting of the scope of the disclosure, as the disclosure may admit to other equally effective embodiments.

FIG. 1 is a chart depicting a mathematically partitioned saline aquifer formation layer guided by flowlines developed from geological reference data correlated thereto.

FIG. 2 is an overview depiction of a geological formation with formation layers that include the saline aquifer formation layer of FIG. 1.

FIG. 3 is a grid depicting an injection well at the saline aquifer formation layer of FIG. 1 surrounded by nodes to facilitate flowline development for the mathematical partitioning.

FIG. 4A is a schematic front view of an exemplary partition of the saline aquifer formation layer of FIG. 1 made up of combined platonic portion shapes.

FIG. 4B is a schematic front view of another exemplary partition of the saline aquifer formation layer of FIG. 1 made up of combined platonic portions of somewhat different shapes.

FIG. 4C is a schematic front view of still another exemplary partition of the saline aquifer formation layer of FIG. 1 made up of combined platonic portions of still further differing shapes.

FIG. 4D is a chart depicting a mathematically partitioned saline aquifer formation layer guided by flowlines as illustrated in FIG. 1 and employing platonic shape arrangements as illustrated in FIGS. 4A-4C.

FIG. 5 is a flow-chart summarizing an embodiment of mathematically partitioning a saline aquifer formation layer developed from flowlines to simulate injection of carbon dioxide into the aquifer formation layer.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

In the following description, numerous details are set forth to provide an understanding of the present disclosure. This includes description of the surrounding environment in which embodiments detailed herein may be utilized. Additionally, it will be understood by those skilled in the art that the embodiments described may be practiced without these and other particular details. Further, numerous variations or modifications may be employed which remain contemplated by the embodiments as specifically described.

Embodiments are described with reference to certain techniques for simulating carbon dioxide injection to a saline aquifer geological formation layer. For example, an illustrative embodiment of the application details the simulation of such an injection in an offshore environment. The techniques include establishing injection parameters for the carbon dioxide and correlating certain geological reference geological reference data to the aquifer formation layer 200. Thus, mathematically partitioning the formation layer into discrete partitions for analysis and estimating of carbon dioxide flow characteristics may be undertaken in a practical manner. Of course, these techniques may be applied to any number of operation field types including in the onshore environment. Indeed, so long as a practical mathematical partitioning takes place employing geological reference data correlated to the saline aquifer formation layer for sake of the simulating, appreciable benefit may be realized.

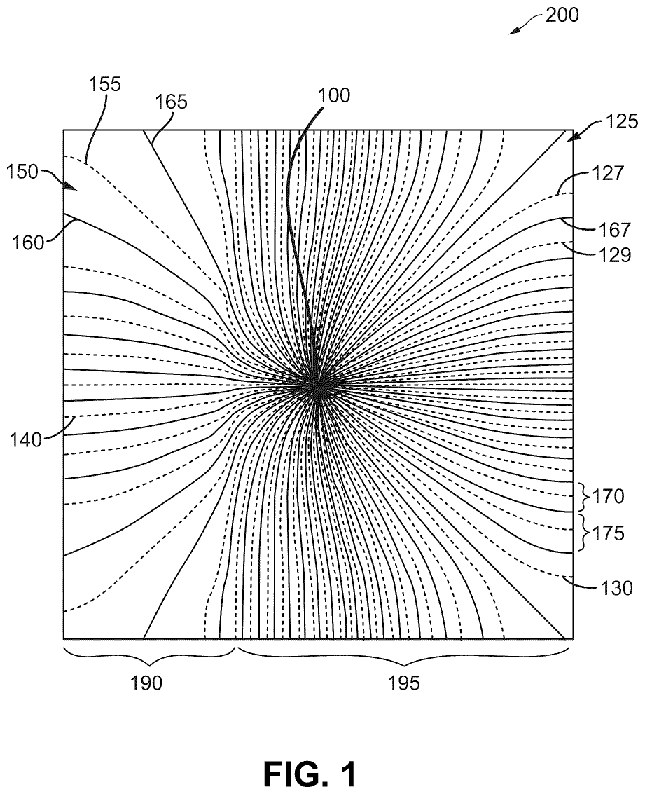

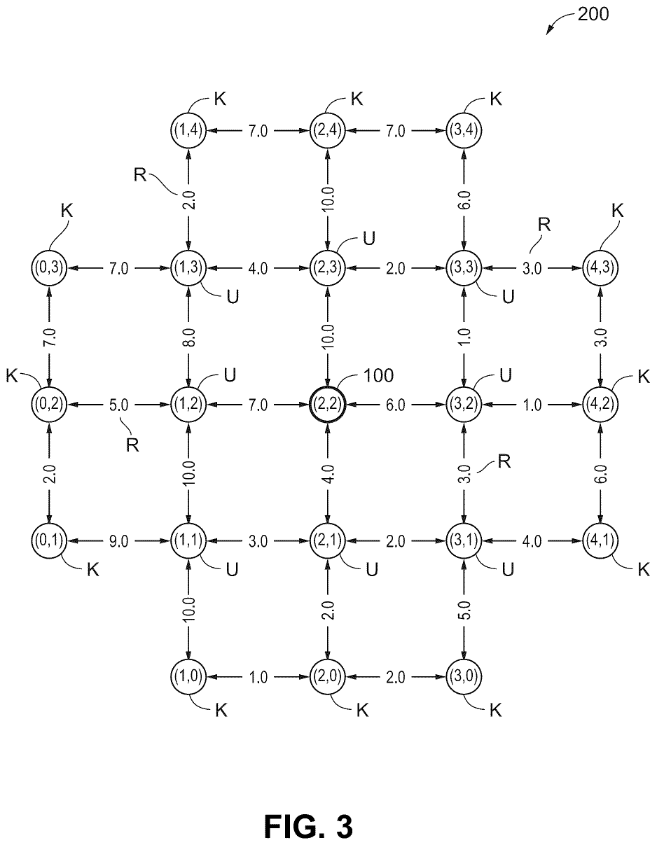

Referring specifically now to FIG. 1, a chart depicting a mathematically partitioned saline aquifer formation layer 200 is shown. Specifically, the depiction presents various discretized partitions 125, 150, 170, 175 (and a host of others). This partitioning or tessellating is guided by flowlines 127, 129, 130, 140, 155 (and more) which are illustrated as dashed lines in the chart of FIG. 1 which run from an injection well 100 that is in fluid communication with the aquifer formation layer 200. Specifically, 60 flowlines (e.g. 127, 129, 130, 140, 155) are developed from a grid as shown in FIG. 3 that employs geological reference data correlations from which to develop these flowlines. Of course, any number of flowlines 127, 129, 130, 140, 155 may be developed in this manner. Also, notice that for the depiction illustrated, the flowlines 125, 150, 170, 175 all reach the boundaries of the aquifer formation layer. However, this may not always be the case. For example, the grid of FIG. 3 employing geological reference data correlations may indicate the presence of a leak or other condition which might indicate a premature termination for a given flowline as discussed further below.

Once the flowlines 127, 129, 130, 140, 155 are generated, the tessellating into the partitions 125, 150, 170, 175 may take place. More specifically, solid line borders 160, 165, 167 (and a host of others) may be set between each adjacent flowline 127, 129, 130, 140, 155. By way of specific example, looking at the top right partition 125, a top right flowline 127 is shown which runs through the partition 125. In setting the solid line border 167 below this flowline 127, the next flowline 129 below the top right flowline 127 is accounted for and this particular solid line border 167 runs a course that separates the top right flowline 127 and the adjacently below flowline 129, constituting non-communicating partitions. This process is repeated over and over between every two adjacent flowlines 127, 129, 130, 140, 155 until this tessellating with solid line borders is complete 160, 165, 167 and the partitions 125, 150, 170, 175 have all been drawn up as illustrated.

Continuing with reference to FIG. 1, the aquifer formation layer 200 is of a visibly heterogenous nature. For example, the depicted 60 flowlines 127, 129, 130, 140, 155 do not follow radially uniform pathways, all at about 6° apart, as they emerge from the injection well 100 and traverse the aquifer formation layer 200 to help develop 60 partitions 125, 150, 170, 175. Of course, this type of presentation might be possible with a more homogenous aquifer formation layer 200. Nevertheless, for the heterogenous aquifer formation layer 200 shown, a pressure potential form of guidance is provided by the grid of FIG. 3 as described below to mathematically develop the unique manner of distribution illustrated. Indeed, note a high resistance region 190 of the aquifer formation layer 200 in contrast to a low resistance region 195. That is, due to differing formation characteristics, namely lower porosity and permeability, a high resistance region 190 of the aquifer formation layer 200 is shown that presents more of a challenge to pumping carbon dioxide through from the injection well 100. So, for example, note the fewer flowlines (e.g. 140, 155) and partitions (e.g. 150) in the high resistance region 190. By way of contrast, the greater number of flowlines (e.g. 127, 129, 130) and partitions (e.g. 125, 170, 175) in the low resistance region 195 reflects a favoring of flow in this direction away from the injection well 100 as injection operations proceed.

Continuing with reference to FIG. 1, for another embodiment not illustrated, the flowlines may be generated about the injection well 100 at uniform angles and employed as central lines. That is, even where more detailed guidance from the grid of FIG. 3 is not employed for sake of flowline placement, the partitions 125, 150, 170, 175 may still be developed and segmented into smaller portions with reference data as described below through Voronoi tessellation. Thus, quick carbon dioxide injection simulations may still be available.

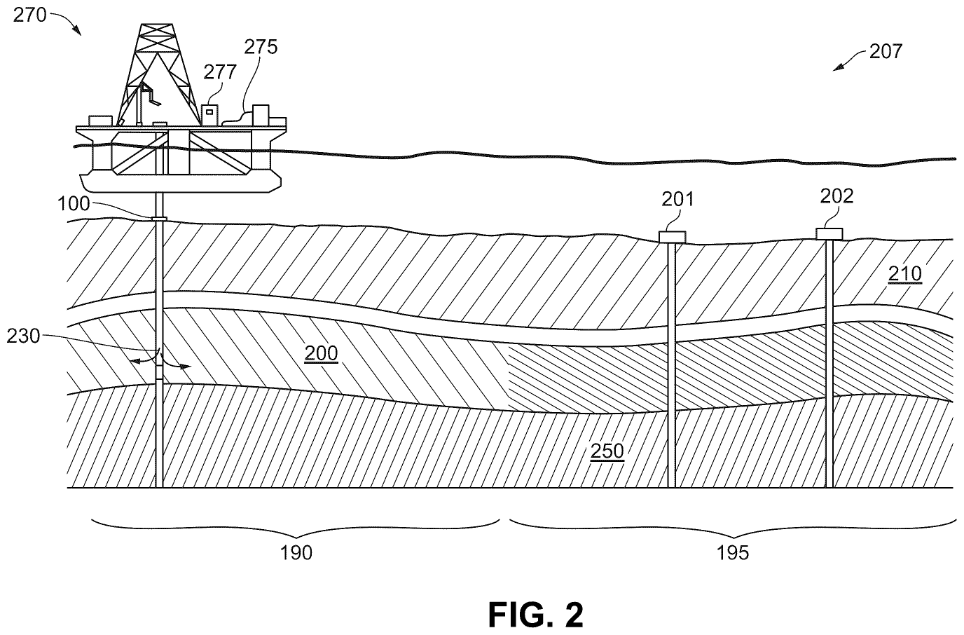

With added reference to FIG. 2, the saline aquifer formation layer 200 is a charted representation of this same layer 200 which is depicted in the overview of FIG. 2. That is, FIG. 1 is presented as a planar top view of this formation layer 200 with the noted injection well 100 near the center of the layout. It is this location to which carbon dioxide waste might be pumped or injected to the aquifer formation layer 200. Thus, quickly and reliably simulating how such flow might occur in advance of the carbon dioxide delivery may be of benefit.

With added reference to FIG. 2, note that apart from the injection well 100, other abandoned wells 201, 202 are also present. Therefore, depending on the amount of carbon dioxide to be delivered and/or potential pressures that might result, the formation layer 200 may or may not be a good candidate location for carbon dioxide storage. This may also depend on the structural integrity of these abandoned wells 201, 202. Of course, even apart from these wells 201, 202 and their potential leak tolerances or profiles, the formation layer 200 may have other limitations itself. For example, the overall volume or carbon dioxide saturation capacity of the aquifer formation layer 200 is a primary factor in determining whether this layer 200 is a suitable candidate for the anticipated carbon dioxide storage, regardless of the presence of any abandoned wells 201, 202. By way of specific example, where 20 million metric tons of carbon dioxide waste is to be dealt with but the aquifer formation layer 200 might only accommodate 2 million metric tons of carbon dioxide waste, the effort necessary to inject and deliver only a small portion of the waste may render the formation layer 200 a poor candidate option for the carbon dioxide storage.

With continued added reference to FIG. 2, the above-described partitioning as illustrated may be guided by geological reference data that is utilized to develop the flowlines 127, 129, 130, 140, 155. For example, recall that the layout of the operation field 207 may have originally been designed with hydrocarbon production from various wells 100, 201, 202 in mind. This means that during design, appraisal and subsequent drilling operations a host of well logging information has been acquired and likely stored. Thus, even though the aquifer formation layer 200 was not the target of production operations, it was likely evaluated to some degree just like other adjacent formation layers 210, 250. This means that seismic data, geological maps or logging data obtained through any of the wells 100, 201, 202 may constitute pertinent geological reference data that might be correlated to the aquifer formation layer 200 which is now of particular interest. Once more, even outside of the illustrated operation field 207, adjacent geological formations, perhaps further away but similarly comparable, may render available reference data. Similarities that are pertinent for referencing may include characteristics of porosity, permeability, pressures, geometries of the saline aquifer formation and aquitard or fluid properties such as density, viscosity and relative permeability.

Whatever the case, once suitable geological reference data is identified, it may be used in making correlations to the aquifer formation layer 200 via the technique described with reference to FIG. 3 which may help to develop the noted flowlines 127, 129, 130, 140, 155. Thus, guidance is available to help draw up the different partitions (e.g. 125, 150, 170, 175 and others) as illustrated in FIG. 1.

Referring specifically now to FIG. 2, an overview depiction of an operation field 207 is shown with formation layers 210, 200, 250 that include the saline aquifer formation layer 200 of FIG. 1. While the depicted wells 201, 202 were drilled and completed with hydrocarbon production operations in mind, focus is now drawn to the possibility of drilling an injection well 100 to inject carbon dioxide into the aquifer formation layer 200 (see arrows 230).

In the example shown, the operation field 207 is offshore and the carbon dioxide waste may be brought to a platform 270. Note the illustration of an injection pump 275 at the platform 270 along with a control unit 277 which may be used to direct a variety of operations, perhaps even including the simulation techniques described herein. Of course, the techniques described herein may be carried out in other manners by way of other equipment and even at onshore operation field 207 locations. Regardless, as part of the simulating of carbon dioxide delivery under consideration, certain injection parameters may be established for consideration. For example, in thinking of the flowing carbon dioxide 230, injection parameters of flowrate, duration, overall volume and the pressure of the supply may be set and considered. Thus, returning briefly with reference to FIG. 1, the flow 230 shown in FIG. 2 may be evaluated on a partition by partition basis.

Returning again to FIG. 1, the simulated different flowlines 127, 129, 130, 140, 155, emanating from the injection well 100 proceed through different partitions 125, 150, 170, 175 and encounter different presumed formation characteristics, depending on the partition 125, 150, 170, 175 at hand. As indicated above, in the illustrated example, a partition (e.g. 150) in one region 190 may have comparatively lower porosity and permeability characteristics as compared to a partition (e.g. 125) in another region 195, for example, due to different rock types.

Referring now to FIG. 3, a grid depicting the injection well 100 at the saline aquifer formation layer 200 of FIG. 1 is shown. This grid is the tool employed to develop the flowlines 127, 129, 130, 140, 155 shown in FIG. 1, from which the illustrated tessellating and subsequent partitioning described below may take place. The injection well 100 is considered a “node” or a point of interest that is surrounded by a plurality of other nodes which are each labeled as U or K. Specifically, as described further below, at the outset, pressure potential values for any given node may be unknown (U) or known (K). Each node (whether 100, U or K) is at a designated position on the grid. For example, the injection well 100 is located at position 2,2 and is surrounded by eight nodes (U) of unknown value at positions 1,2, 2,3, 3,3, 1,2, 3,2, 1,1, 2,1, and 3,1. Of course, the pressure potential values of the injection well 100 at position 22 is known because of the carbon dioxide application parameters that are to be employed for the simulation being tested. The remaining twelve nodes (K) are also of known or determinable values at the outset. Notice that these “known” nodes (K) are at the perimeter of the grid representing the aquifer formation layer 200 and represent boundary conditions.

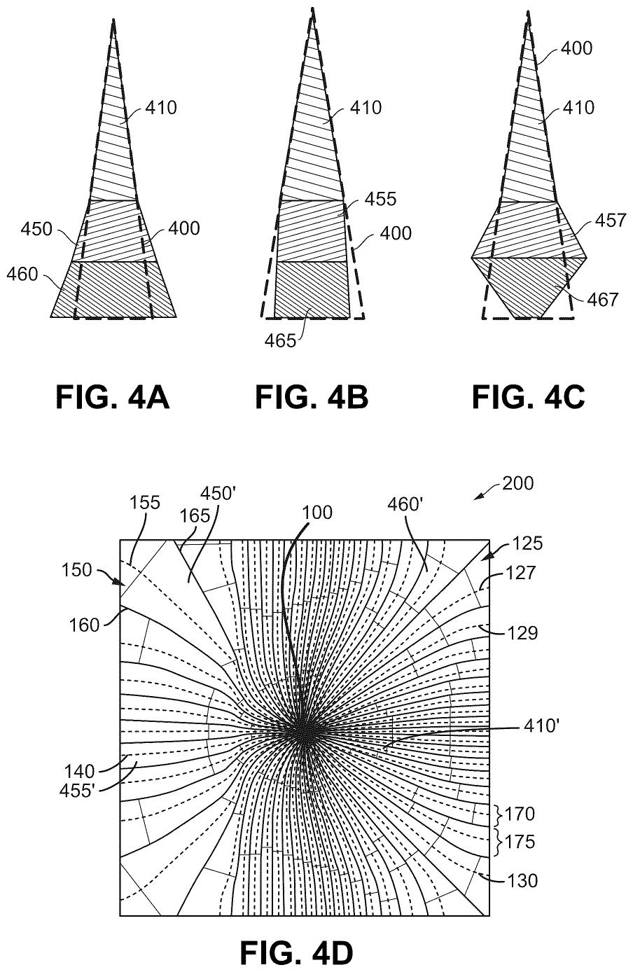

As described further below, the determinable or known value nodes (K) obtain a known value by assigning a constant pressure resistance value outside of the grid boundary. This metric, along with assigned geologic reference data and injection parameters may be employed in an electrical circuit analogy to develop resistance values (R), in the grid manner as shown, between all nodes (100, U, K). Notice the exemplary numerical values at all R locations between each node position on the grid of FIG. 3. Ultimately, this may be used to develop the flowlines 127, 129, 130, 140, 155 of FIG. 1. This in turn facilitates development of the tessellated partitions 125, 150, 170, 175 of FIG. 1 which may later be portioned as shown in FIGS. 4A-4D to render a fast carbon dioxide simulation. Thus, as suggested, the manner of quickly obtaining carbon dioxide simulation results employs an electrical circuit analogy as described below.

As suggested, a method similar to an electrical circuit is employed to calculate an initial pressure potential. Each node 100, U, K is analogous to an electrical potential node and the nodes are interconnected forming a structure similar to an electrical circuit as illustrated by the grid of FIG. 3. With this in mind, Ohm's law is considered here in Eq. 1.

$${I}_{i j} = \frac{{U}_{i} - {U}_{j}}{{R}_{i j}} \qquad ( 1 )$$

Similarly, based on Darcy's law, an analogous equation for fluid flow is available (see Eq. 2 here).

$${Q}_{i j} = \frac{( {P}_{i} - {P}_{j} )}{\frac{μ}{{T}_{ij}}} \qquad ( 2 )$$

These two equations exhibit a strong similarity and an analogy between the flow rate Qᵢⱼ between two grid cells and an electric current Iᵢⱼ, fluid pressure Pᵢ and the electrical potential Uᵢ, and the ratio of fluid viscosity to the transmissibility

$$( \frac{μ}{{T}_{i j}} )$$

between grid cells and the electrical resistance Rᵢⱼ.

The illustration here provides a schematic top view of two adjacent grids. Lᵢⱼ represents the distance between the centers of grids, and wᵢⱼ denotes the width of the cross-section between the two grids.

Expanding the transmissibility in Eq.2 from above, the resistance may be expressed as analogous to:

$${R}_{i j} ∼ \frac{{L}_{i j}}{{w}_{i j} H} \frac{μ}{{k}_{i j}} \qquad ( 3 )$$

where Lᵢⱼ is the distance between the nodes, wᵢⱼ is the width of the cross-section, H is the thickness of the grid, μ is the fluid viscosity, and kᵢⱼ is the permeability.

With the nodes and the resistances (R) between them in mind, a system that is analogous to an electrical circuit may be constructed. To calculate the pressure potential in this system, a high electrical potential may be assigned at the location of the injection well 100. In other parts of the aquifer formation layer 200, different setups may be applied based on specific reservoir conditions. For example, consider the following conditions:
Constant Pressure Boundary: A boundary or edge of the aquifer formation layer 200 may be assigned a constant pressure based on geologic reference data with nodes external to the boundary set to low electrical potential, for example, assigned a value of 1.
No-Flow Boundary: Where the boundary or edge of the aquifer formation layer 200 is considered a no-flow boundary based on geologic reference data, the edges connected to these boundary nodes (K) may assigned very high resistance, for example, being assigned a value of 1 billion, making the inflow current negligible.
Areal Heterogeneities: For internal areal heterogeneities in the aquifer, the resistance values may be set differently based on the definition of Rᵢⱼ (see Eq. 3).
Fluid Leakage Through Legacy Wells: To account for the impact of fluid leakage through a legacy or abandoned well (e.g. see 201 or 202 of FIG. 2), a node at the location of the such a well 201, 202 may be set to low electrical potential as noted above, or new edges and nodes may be introduced at the connection points. The configuration is adjusted to simulate the specific leakage scenario (e.g. sink formation pressure and well leakage parameter).
Structural Dip: For structural dip, an electrical potential difference may be added to the relevant internal and boundary nodes based on the pressure potential formed by gravity, for example, to simulate the fluid movement caused by gravitational effects between wells and boundaries.
Vertical Heterogeneity: For cases where vertical heterogeneity is assigned based on geologic reference data, for example, where multiple reservoirs with different properties are vertically adjacent and hydraulically connected, the electric circuit can be extended to a 3D structure. In this setup, each layer contains a 2D electric circuit in the horizontal direction, while the layers are also connected at relevant points in the vertical direction. By assigning resistivity values (R) but in a vertical direction, the cross-layer fluid flow trends may also be simulated. This approach allows the calculation of the pressure potential in a 3D structure with vertically heterogeneous, multilayer reservoirs.
Fluid Compressibility: The influence of fluid compressibility on pressure response may be represented by a capacitance term in the circuit analogy, capturing storage effects in the porous medium. This formulation enables quantification of both the dissipative effect of compressibility on pressure transmission and the associated retardation of diffusive propagation.

After setting the electrical potential at the injection well 100 and the aquifer boundaries, configuring the resistance on each internal edge, and defining the conditions for the leaking well, it is possible to proceed to solve for the electrical potential values at each node. There are different methods available to solve the electrical potential values at these nodes. Here, we can use an analytical approach by applying Kirchhoff's Current Law to find the solution.

Returning with specific reference to FIG. 3, a simplified diagram of node connections is shown as described above. The resistance (R) between all nodes is known as calculated based on the conditions of the aquifer. So, for example, consider an exemplary scenario where node (2,2) represents the location of the injection well 100 as described above and where a known high electrical potential is applied as also described above. The nodes at the four edges of the illustration (nodes (0,1), (0,2), (0,3), (1,0), (2,0), (3,0), (4,1), (4,2), (4,3), (3,4), (2,4), (1,4)) may be set to low electrical potential, corresponding to a constant pressure boundary as described above. Thus, the task is to solve the electrical potential at the remaining nodes (U).

With the above in mind, consider node (1,3) in an example scenario, based on Kirchhoff's Current Law (see Eq. 4):

$$\frac{{U}_{( 0 , 3 )} - {U}_{( 1 , 3 )}}{{R}_{( 0 , 3 ) \sim ( 1 , 3 )}} + \frac{{U}_{( 1 , 4 )} - {U}_{( 1 , 3 )}}{{R}_{( 1 , 4 ) \sim ( 1 , 3 )}} + \frac{{U}_{( 2 , 3 )} - {U}_{( 1 , 3 )}}{{R}_{( 2 , 3 ) \sim ( 1 , 3 )}} + \frac{{U}_{( 1 , 2 ) -} {U}_{( 1 , 3 )}}{{R}_{( 1 , 2 ) \sim ( 1 , 3 )}} = 0 \qquad ( 4 )$$

Thus, the following would be applicable:
U_{(1,3)}: Electrical potential at node (1,3)
U_{(0,3)}, U_{(1,4)}, U_{(2,3)}, U_{(1,2)}: Electrical potentials at the neighboring nodes
R_{(0,3)~(1,3)}, R_{(1,4)~(1,3)}, R_{(2,3)~(1,3)}, R_{(1,2)~(1,3)}: Resistances between node (1,3) and its neighboring nodes

This equation ensures that the net current at node (1,3) is zero, as required by Kirchhoff's Current Law.

Eq. (4) can be rewritten in matrix form (e.g. as Eq. 5 here):

$$[ - \frac{1}{{R}_{( 0 , 3 ) ∼ ( 1 , 3 )}} - \frac{1}{{R}_{( 1 , 4 ) ∼ ( 1 , 3 )}} - \frac{1}{{R}_{( 2 , 3 ) ∼ ( 1 , 3 )}} - \frac{1}{{R}_{( 1 , 2 ) ∼ ( 1 , 3 )}} \frac{1}{{R}_{( 2 , 3 ) ∼ ( 1 , 3 )}} 0 \frac{1}{{R}_{( 1 , 2 ) ∼ ( 1 , 3 )}} 0000 ] \\ [ \begin{matrix}{U}_{( 1 , 3 )} \\ {U}_{( 2 , 3 )} \\ {U}_{( 3 , 3 )} \\ {U}_{( 1 , 2 )} \\ {U}_{( 3 , 2 )} \\ {U}_{( 1 , 1 )} \\ {U}_{( 2 , 1 )} \\ {U}_{( 3 , 1 )}\end{matrix} ] = [ \frac{{U}_{( 0 , 3 )}}{{R}_{( 0 , 3 ) \sim ( 1 , 3 )}} + \frac{{U}_{( 1 , 4 )}}{{R}_{( 1 , 4 ) \sim ( 1 , 3 )}} ] \qquad ( 5 )$$

In fact, every node with an unknown electrical potential, including node (1,3), can be expressed in the matrix form described above. The second term on the left-hand side of these matrix equations corresponds to a vector that consolidates the electrical potential of all unknown nodes. When these matrices are combined, the system can be expressed in the following form (see Eq. 6):

$$A * U = B \qquad ( 6 )$$

$$where$$

$$A = [ \begin{matrix}- \frac{1}{{R}_{( 0 , 3 ) ∼ ( 1 , 3 )}} - \frac{1}{{R}_{( 1 , 4 ) ∼ ( 1 , 3 )}} - \frac{1}{{R}_{( 2 , 3 ) ∼ ( 1 , 3 )}} - \frac{1}{{R}_{( 1 , 2 ) ∼ ( 1 , 3 )}} \frac{1}{{R}_{( 2 , 3 ) ∼ ( 1 , 3 )}} & 0 & \frac{1}{{R}_{( 1 , 2 ) ∼ ( 1 , 3 )}} & 0 & 0 & 0 & 0 \\ ⋮ & & & & & & ⋮\end{matrix} ] \qquad ( 7 )$$

$$U = [ \begin{matrix}{U}_{( 1 , 3 )} \\ {U}_{( 2 , 3 )} \\ {U}_{( 3 , 3 )} \\ {U}_{( 1 , 2 )} \\ {U}_{( 3 , 2 )} \\ {U}_{( 1 , 1 )} \\ {U}_{( 2 , 1 )} \\ {U}_{( 3 , 1 )}\end{matrix} ] \qquad ( 8 )$$

$$B = [ \frac{{U}_{( 0 , 3 )}}{{R}_{( 0 , 3 ) \sim ( 1 , 3 )}} + \frac{{U}_{( 1 , 4 )}}{{R}_{( 1 , 4 ) \sim ( 1 , 3 )}} ] \qquad ( 9 )$$

In the above matrix:
A is the coefficient matrix, which includes the conductance (inverse of resistances) between connected nodes.
U is a column containing the electrical potential of all the nodes that are unknown.
B is a column vector that incorporates the contributions from nodes with known electrical potential (e.g., high electrical potential at the injection well or low electrical potential at constant pressure boundaries).

For each unknown node (U),
the corresponding row in the matrix A includes:
   1) A diagonal term that is the sum of the negative conductance connected to that node.
   2) Off-diagonal terms that are the conductance between the current node and its neighboring nodes with unknown electrical potential.
If a neighboring node has a known electrical potential, its contribution is moved to the corresponding row in B.

As all the elements in A and B are known, we can determine the electrical potential (pressure potential) at all unknown nodes by solving this matrix system,

$$U = {A}^{- 1} B \qquad ( 10 )$$

This method can be extended to cases with a denser node configuration. For example, consider a grid extending beyond that of FIG. 3 to one such as here. In this case, the aquifer formation layer 200 of FIG. 3 is now presented with denser nodes across the layer 200. This means that the number of unknown nodes (U) may be greater. Yet, the pressure values may still be available through application of Eq. 10 above.

Similar to the concepts noted above, this method can also handle more complex scenarios, such as:
Multiple injection wells (i.e., multiple known high-electrical potential nodes).
No-flow boundaries (i.e., assigning very large resistance values to the corresponding edges).
Heterogeneous aquifers (i.e., assigning different resistance values to represent varying aquifer properties).
Leaking wells (i.e., setting the corresponding node to a known electrical potential or introducing new edges and nodes to model the leakage).
Structural Dip (i.e., adding an electrical potential difference to the relevant internal and boundary nodes based on the pressure potential formed by gravity)
Vertical Heterogeneity (i.e., extending the electric circuit to a 3D structure and simulating the vertical cross-layer fluid flow by adding resistance between layers)

Further, in addition to adding node number along the lines of the grid above, complexity may also be added by increasing the number of nodes near the injection well 100. That is, rather than presenting nodes equidistant as illustrated above and at FIG. 3, the grid structure may include a denser node population nearer the well 100 that is more distributed further from the injection well 100. Thus, the ultimate simulation obtained may be of a finer resolution nearer the injection location. Further, in another embodiment, a finer resolution may be obtained while maintaining the original grid structure of FIG. 3. In this embodiment, prism-shaped regions between the injection well 100 and the eight neighboring nodes (1,3, 2,3, 3,3, 1,2, 3,2, 2,1 and 3,1) may be employed for added pressure based calculations with the electrical circuit method and techniques described herein, now applied to additionally available platonic shapes as shown with the grid prism block example here.

Thus, while technically not introducing additional nodes for consideration, an added level of refinement may occur with midline pressure values performed to estimate pressure at additional arbitrary points (e.g. B, C, D, E, F, G, H and I) in the near-well region, resulting in enhanced accuracy of pressure distribution nearer the injection well 100 (e.g. point A above).

After obtaining the electrical potential values at each node, computing the pressure potential across the entire aquifer formation layer 200 may take place. Returning to FIG. 1, based on these potentials, a determination of the flowlines 127, 129, 130, 140, 155 (and more) from the injection well 100 to the boundary of the aquifer formation layer 200 (or to a potentially leaking well) may take place in a manner that facilitates the depicted trajectories.

Referring now to FIGS. 4A-4C, schematic front views of exemplary partitions 400 of the saline aquifer formation layer 200 of FIG. 1 are shown. More specifically, looking at the rough dashed outline for each partition 400, it is evident that each is made up of combined platonic shape portions 410, 450, 455, 457, 460, 465, 467. That is, just as is evident in FIG. 1, each partition 400 is not a homogeneous, uniform shape, but rather, takes on a bit of an amorphous nature as guided by the above-noted trajectories of the flowlines 127, 129, 130, 140, 155 (again, see FIG. 1).

With the above in mind, each partition 400 may be broken down into an assembly of more manageable platonic shapes 410, 450, 455, 457, 460, 465, 467. Utilizing canonical platonic shapes, such as a prism 410 or a cuboid 450, 455, 457, 460, 465, 467, to make up a given partition 400 means that readily understood and calculatable geometries and areas are available to work with. As used herein, the term “prism” may encompass other triangular three-dimensional shapes apart from that illustrated and the term “cuboid” may include rectangular and trapezoidal shapes as well. Regardless, as a matter of utility, geological reference data in terms of permeability and porosity may be applied across one platonic shape 410, 450, 455, 457, 460, 465, 467 at a time for independent calculations. This may also be combined for cumulative information regarding a given partition 400 where of value. Either way, from a computational standpoint, geological characteristic reference data may now be applied across a predetermined platonic shape area with known carbon dioxide pump injection parameters applied thereto for sake of fast and practical simulation. In sum, with such reference data applied to a known platonic shape combination in light of injection parameters to be tested, a quick and practical estimation of pressure and saturation within the partition 400 at a given point in time may readily be simulated. In keeping with the illustrated scenario of FIG. 2, this may be of significance where an abandoned well 201 or 202 is present within a given partition 400 at hand for which potential pressure exposures and leak tolerances may be under consideration.

Referring specifically now to FIG. 4D, a chart depicting a mathematically partitioned saline aquifer formation layer 200 is shown. As with the representation of FIG. 1, the partitioning is guided by flowlines 127, 129, 130, 140, 155. However, now the partitions 125, 150, 170, 175 are further divided into manageable platonic shapes (e.g. 410′, 450′, 455′, 460′ and others). This substantially enhances computational efficiency, particularly in terms of establishing quick, time based calculations for saturation and pressure for a given carbon dioxide injection simulation.

With this as a backdrop, more complex saturation, pressure and plume thickness calculations may be considered. For each time point of interest, these calculations are independent of other time points. At the same time, the results at later time points do not depend on the results from earlier time points. Thus, the technique described is not limited to a numerical simulator but rather, more substantially enhances computational efficiency. More specifically, the saturation calculation may be carried out in two steps as indicated here:

### 1. Saturation Along Central Flowlines

First, based on the shape of the block formed by merging each region, analytical solutions may be employed to compute the variation in CO₂ plume thickness within a given region. The CO₂ saturation is then derived as the ratio of the CO₂ plume thickness to the total aquifer thickness. This calculated CO₂ plume saturation is taken as the result along the pertinent flowline. By way of example, the illustration here shows the CO₂ saturation results along all the central flowlines after 1,095 days of continuous CO₂ injection (e.g. for a largely heterogeneous, aquifer formation layer).

### 2. Aquifer-Wide Interpolation

Next, using the saturation results from all the central flowlines, interpolation is performed across the entire aquifer formation layer. This provides saturation values for all grids in the aquifer formation layer, ensuring consistency in the overall saturation distribution. The illustration here presents such results of the saturation interpolation across an entire aquifer formation layer.

The pressure within the aquifer may be computed using the electrical network method, based on the updated saturation results. In the initial pressure computation described above, the resistivity was calculated assuming single-phase flow, where the aquifer contains only a single fluid phase. However, considering the dynamic nature of the simulated application and since the saturation values at different locations in the aquifer for various time points may have been determined, the resistivity values may now be updated accordingly. More specifically, for two-phase flow, the resistivity is defined as follows:

$${R}_{ij} = \frac{{L}_{ij}}{{w}_{ij} {Hk}_{ij}} ( \frac{1}{\frac{{k}_{rCO2}}{{μ}_{CO2}} {S}_{CO2} + \frac{{k}_{rw}}{{μ}_{w}} ( 1 - {S}_{CO2} )} ) \qquad ( 11 )$$

where k_{rCO2} is the relative permeability of carbon dioxide, k_{rw} is the relative permeability of saline water, μ_{CO2} is the viscosity of carbon dioxide, μ_{w} is the viscosity of saline water, and S_{CO2} is the saturation of carbon dioxide.

After updating the resistivity on each edge between nodes, the matrices A (in Eq. (7)) and B (in Eq. (9)) may also be updated. Using Eq. (10), recalculating the pressure values at all nodes may ensue, so as to further enhance the simulation results in terms of obtaining time conscious estimates.

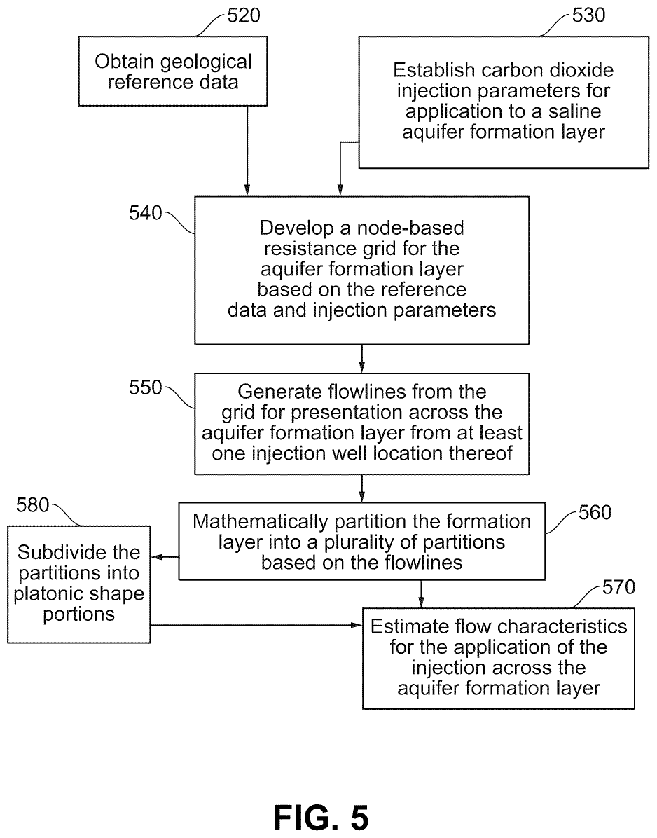

Referring specifically now to FIG. 5, a flow-chart is shown which summarizes an embodiment of mathematically partitioning a saline aquifer formation layer developed from flowlines to simulate injection of carbon dioxide into the aquifer formation layer. The flow-chart summary encompasses the techniques described above and relies upon the availability of geological reference data as noted in 520. As described above, this may be data from a neighboring oilfield or other geological site or even perhaps the same site, for example, where the site in question is an oilfield which is no longer producing. Such locations are likely to have available data from prior operations at the location which may now be available for use in the present simulation endeavors. As to the simulation itself, parameters may be set for the carbon dioxide injection application which might be directed to a saline aquifer formation layer at the geologic site (see 530).

With the above information in hand, a node-based resistance grid may be set up for the aquifer formation layer under consideration as indicated at 540. This grid may be used to generate flowlines that run from one or multiple injection well locations of the aquifer formation layer to locations running across the formation layer (see 550). Once the flowlines have been generated, a mathematical partitioning may take place based on these flowlines as noted at 560 in order to obtain a plurality of partitions. As noted at 570, the resulting partitions may render a manageable way of estimating flow characteristics on a partition by partition basis. In fact, as indicated at 580, as a matter of rendering even more manageable shapes and areas, the partitions may be further subdivided into platonic shape portions in advance of providing the estimated simulation of flow characteristics. Thus, traditional canonical shapes of readily available and conventional dimensions may be used in providing the simulation.

Embodiments of techniques are detailed herein that facilitate modeling of a saline aquifer in a practical matter that allows for the simulating of carbon dioxide injection into the aquifer. The techniques account for the fact that such aquifers are unlikely to be homogenous in terms of porosity and permeability characteristics, while at the same time rendering a practical and quick manner of simulation.

### ADDITIONAL CONSIDERATIONS

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. Regardless, the foregoing description should not be read as pertaining only to the precise structures described and shown in the accompanying drawings but rather should be read as consistent with and as support for the following claims, which are to have their fullest and fairest scope.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of simulating carbon dioxide injection into a saline aquifer, the method comprising:
obtaining geological reference data correlated to a saline aquifer formation layer;
establishing a set of carbon dioxide injection parameters for simulation of an injection application directed through at least one injection well in fluid communication with the saline aquifer formation layer;
mathematically plotting a plurality of flowlines emanating from the at least one injection well, each flowline of the plurality of flowlines traversing the aquifer formation layer;
partitioning the saline aquifer formation layer into a plurality of discrete partitions based on the mathematical plotting of the plurality of flowlines; and
estimating carbon dioxide flow characteristics for each discrete partition of the plurality based on the geological reference data and the carbon dioxide injection parameters.

2. The method of claim 1 wherein each flowline of the plurality of flowlines traverses the aquifer formation layer to reach one of a boundary of the saline aquifer formation layer and a leakage point of the saline aquifer formation layer.

3. The method of claim 1 wherein the mathematically plotting a plurality of flowlines comprises establishing a node-based resistance grid for the aquifer formation layer based on the geological reference data and the carbon dioxide injection parameters.

4. The method of claim 1 wherein the carbon dioxide injection parameters include one of flowrate, duration, volume and pressure of injected carbon dioxide.

5. The method of claim 1 wherein a trajectory of each flowline of the plurality of flowlines is established based on at least one of a location of the at least one injection well, a leakage point at the aquifer formation layer, a boundary condition of the aquifer formation layer, a distribution of porosity of the aquifer formation layer, and a distribution of permeability of the aquifer formation layer.

6. The method of claim 1 wherein the geological reference data comprises one of permeability and porosity characteristics.

7. The method of claim 6 wherein the geological reference data comprises one of inferred logging data from an operation field including the saline aquifer formation layer and inferred data estimates based on comparable geological formations.

8. The method of claim 1 further comprising subdividing the plurality of discrete partitions into platonic shape portions in advance of the estimating of the carbon dioxide flow characteristics.

9. The method of claim 8 wherein the platonic shape portions are one of prism and cuboid shapes.

10. A method of simulating carbon dioxide injection into a saline aquifer, the method comprising:
obtaining geological reference data correlated to a saline aquifer formation layer;
establishing a set of carbon dioxide injection parameters for simulation of an injection application directed through at least one injection well in fluid communication with the saline aquifer formation layer;
developing a node-based resistance grid for the aquifer formation layer based on the geological reference data and the set of carbon dioxide injection parameters;
mathematically plotting a plurality of flowlines along the node-based resistance grid with each flowline emanating from the at least one injection well;
partitioning the saline aquifer formation layer into a plurality of discrete partitions based on the mathematical plotting of the plurality of flowlines; and
estimating carbon dioxide flow characteristics for each discrete partition of the plurality based on the geological reference data and the set of carbon dioxide injection parameters.

11. The method of claim 10 wherein the node-based resistance grid is one reflective of an equidistant node spacing and one reflective of a non-equidistant node spacing with a denser node layout nearer the at least one injection well.

12. The method of claim 10 further comprising employing midline pressure values at grid locations adjacent the at least one injection well for the mathematically plotting of the plurality of flowlines to enhance accuracy thereof adjacent the at least one injection well.

13. The method of claim 10 further comprising subdividing the plurality of discrete partitions into platonic shape portions in advance of the estimating of the carbon dioxide flow characteristics.

14. The method of claim 13 wherein each platonic shape portion is assigned its own characteristics of porosity and permeability in advance of the estimating of the carbon dioxide flow characteristics.

15. The method of claim 13 wherein the platonic shape portions are one of prism shapes and cuboid shapes.

16. The method of claim 15 wherein the cuboid shapes are one of rectangular and trapezoidal.

17. The method of claim 10 wherein a trajectory of each flowline of the plurality of flowlines is established along the node-based resistance grid based on at least one of a location of the at least one injection well, a leakage point at the aquifer formation layer, a boundary condition of the aquifer formation layer, porosity of the formation layer and permeability of the aquifer formation layer.

18. The method of claim 17 wherein the trajectory of each flowline of the plurality of flowlines is further established by a heterogenous character for one of the porosity and the permeability of the aquifer formation layer.

19. An operation field arrangement comprising:
an injection well at an operation field having a saline aquifer formation layer; and
a control unit for running a simulation of carbon dioxide injection into the aquifer, wherein the simulation includes obtaining geological reference data correlated to the saline aquifer formation layer and accounting for a set of carbon dioxide injection parameters for the simulation wherein the saline aquifer formation layer is represented with a plurality of flowlines developed from a node-based partition grid to facilitate mathematically developing a plurality of discrete partitions for estimating carbon dioxide flow characteristics for each discrete partition of the plurality based on the geological reference data and the carbon dioxide injection parameters.

20. The operation field arrangement of claim 19 further comprising at least one potential leakage point within at least one of the plurality of discrete partitions.
